(19) United States
(12) Patent Application Publication
(10) Pub. No.: US 2025/0160364 A1
(43) Pub. Date: May 22, 2025

(54) PET FOOD COMPOSITIONS AND METHODS FOR MODIFYING STOOL QUALITY

(71) Applicant: MARS, INCORPORATED, McLean, VA (US)

(72) Inventors: Lucio Hiroshi YONEMOTO, Franklin, TN (US); Svetlana ZIVANOVIC, Franklin, TN (US); Katherine P. BOEBEL, Franklin, TN (US)

(73) Assignee: MARS, INCORPORATED, McLean, VA (US)

(21) Appl. No.: 18/841,271

(22) PCT Filed: Feb. 24, 2023
(86) PCT No.: PCT/US2023/013811

§ 371 Date: Aug. 23, 2024

Related U.S. Application Data
(60) Provisional application No. 63/313,428, filed on Feb. 24, 2022.

(51) Int. Cl. A23K 20/147; A23K 10/26; A23K 10/30; A23K 20/158; A23K 40/00; A23K 50/42

(52) U.S. Cl. CPC A23K 20/147; A23K 10/26; A23K 10/30; A23K 20/158; A23K 40/00; A23K 50/42

(57) ABSTRACT

Hydrolyzed keratin-containing materials, methods of preparing such materials, and compositions that include such materials are described. The method can include combining a keratin-containing material with an acid, processing the keratin-containing material by steam hydrolysis, and reducing a particle size of the keratin-containing material. The hydrolyzed keratin-containing material can include 1.0% by weight or less of lanthionine, relative to the total weight of the hydrolyzed keratin-containing material.

### CROSS-REFERENCE TO RELATED APPLICATIONS

This application claims the benefit of priority to U.S. Provisional Patent Application Ser. No. 63/313,428, filed on Feb. 24, 2022, the contents of which are incorporated herein by reference in their entirety.

### TECHNICAL FIELD

The present disclosure generally relates to pet food compositions and methods, including compositions with reduced lanthionine content useful for improving stool quality.

### BACKGROUND

As the demand for alternative sources of protein for use in pet food and other animal feed grows, protein-containing materials such as animal byproducts have become increasingly valuable. For instance, feathers from poultry, and other materials like wool, hair, fur, nails, claws, and bristles typically contain high amounts of keratin protein. Such materials often have poor digestibility, however. Processing of keratin materials to improve digestibility can generate compounds with undesirable gastrointestinal effects.

### SUMMARY

The present disclosure includes hydrolyzed keratin-containing materials, methods of preparing hydrolyzed keratin-containing materials, and compositions that include such materials.

In certain embodiments, a method for preparing a hydrolyzed keratin-containing material includes combining a keratin-containing material with an acid, processing the keratin-containing material by steam hydrolysis, and reducing a particle size of the keratin-containing material to a d₅₀ particle size of 100 μm or less. In certain embodiments, the keratin-containing material can be combined with the acid to achieve a pH ranging from about 2 to about 5 before and/or during processing by steam hydrolysis. In various embodiments, reducing the particle size can occur before combining with the acid, before the processing by steam hydrolysis, and/or after the processing by steam hydrolysis. In some aspects of the present disclosure, the processing by steam hydrolysis can be performed at a pressure of from about 0 to about 100 psig. In certain embodiments, the keratin-containing material can include feathers, hair, wool, beaks, hide, bristles, horns, hooves, claws, nails, scales, or a mixture thereof. Further, in certain aspects of the present disclosure, the hydrolyzed keratin-containing material can include 1.0% by weight or less of lanthionine, relative to the total weight of the hydrolyzed keratin-containing material. Optionally, the hydrolyzed keratin-containing material can include 0.5% by weight or less of lanthionine.

The present disclosure also includes a hydrolyzed keratin-containing material prepared according to the methods described above and elsewhere herein. In certain embodiments, the hydrolyzed keratin-containing material can have a lanthionine content of 1.0% by weight or less, 0.5% by weight or less, or 0.25% by weight or less relative to the total weight of the hydrolyzed keratin-containing material. In certain embodiments, the hydrolyzed keratin-containing material can have a d₁₀ particle size ranging from about 1 μm to about 30 μm, and/or a d₉₀ particle size ranging from about 80 μm to about 160 μm, and/or a d₅₀ particle size ranging from about 30 μm to about 70 μm. In a particular embodiment, the hydrolyzed keratin-containing material can have a Boisen digestibility greater than about 70%, or a Boisen digestibility of about 70% to about 90%.

Also disclosed herein are compositions comprising the hydrolyzed keratin-containing materials disclosed above and elsewhere herein. According to some aspects of the present disclosure, the composition can be a pet food composition. In certain embodiments, the composition can comprise up to about 20% by weight, such as about 1% by weight to about 20% by weight, of the hydrolyzed keratin-containing material. In a particular embodiment, the composition can include 0.2% by weight or less of lanthionine, relative to the total weight of the composition, such as about 0.01% to 0.2% by weight of lanthionine. In some aspects of the present disclosure, the hydrolyzed keratin-containing material can be, comprise, or consist essentially of hydrolyzed feather meal. In certain embodiments, the composition can further include at least one protein source other than the hydrolyzed keratin-containing material. In certain embodiments, the at least one protein source other than the hydrolyzed keratin-containing material can comprise an animal-based protein such as chicken, turkey, beef, pork, lamb, venison, duck, or salmon; and/or a plant-based protein such as corn gluten meal or wheat gluten. In certain embodiments, the composition can further comprise at least one carbohydrate such as corn, rice, wheat, sorghum, or barley; and/or at least one fat such as poultry fat, beef tallow, or vegetal oil.

The present disclosure also includes methods for improving stool quality in an animal. In certain embodiments, the method can include administering a composition as described above and elsewhere herein to the animal. In a particular embodiment, the composition can be a dry pet food. In certain embodiments, the animal can be a dog or a cat. In a particular embodiment, the stool quality value of the animal can be about 2 to about 4. Further, the present disclosure includes uses of the compositions described above and elsewhere herein for improving stool quality of an animal. Optionally, the animal can a dog or a cat. In certain embodiments, the stool quality value of the animal can be about 2 to about 4.

The present disclosure also includes hydrolyzed keratin-containing materials. In certain embodiments, the hydrolyzed keratin-containing material can comprise 1.0% by weight or less of lanthionine, such as less than or equal to 0.5% by weight, lanthionine, relative to the total weight of the hydrolyzed keratin-containing material. The hydrolyzed keratin-containing material can have a d₁₀ particle size ranging from about 1 μm to about 30 μm, a d₉₀ particle size ranging from about 80 μm to about 160 μm, and/or a d₅₀ particle size ranging from about 30 μm to about 70 μm. In a particular embodiment, the hydrolyzed keratin-containing material comprises hydrolyzed feather meal.

The present disclosure also includes a composition comprising up to about 20% by weight, e.g., about 1% by weight to about 20% by weight, of a hydrolyzed keratin-containing material. The composition also can comprise at least 5% by weight of a protein source other than the hydrolyzed keratin-containing material. The composition can be a pet food composition. The composition can comprise 0.2% or less by weight, 0.15% or less by weight, or 0.1% or less by weight lanthionine, relative to the total weight of the composition.

Additional features and advantages of the application will be described hereinafter which form the subject of the claims of the application. It should be appreciated by those skilled in the art that the conception and specific embodiment disclosed can be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### DETAILED DESCRIPTION

Aspects of the present disclosure include methods of preparing keratinous protein-containing materials useful for pet food and pet food compositions comprising such materials. The methods and compositions herein can increase digestibility while maintaining acceptable stool quality.

### Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

As used in the specification and the appended claims, the singular forms “a,” “an” and “the” include plural referents unless the context clearly dictates otherwise. Thus, for example, reference to “a compound” includes mixtures of compounds.

As used herein, the terms “comprises,” “comprising,” “includes,” “including,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to systems or processes, the term can mean within an order of magnitude, preferably within 5-fold, and more preferably within 2-fold, of a value.

In the detailed description herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

### Methods

Low digestibility of keratin-containing materials is understood to relate to the structural integrity of cysteine disulfide bonds. Processing of keratin-containing materials by prior methods can result in form compounds with undesirable gastrointestinal effects.

Lanthionine is an amino acid formed from cysteine:

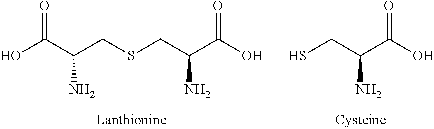 [SMILES: N[C@@H](CSC[C@H](N)C(=O)O)C(=O)O ; N[C@@H](CS)C(=O)O]

While lanthionine is present in keratin-containing materials in small amounts, harsh processing conditions such as high heat, high pressure, and/or use of alkali agents can considerably increase the materials' lanthionine content. The methods disclosed herein, including hydrolysis under acidic pH conditions and size reduction, have been found to increase digestibility of keratin-containing materials with relatively low amounts of lanthionine. The relatively low amount of lanthionine can provide for pet food compositions that avoid undesirable gastrointestinal effects, such as diarrhea or loose stool. Thus, the compositions and methods herein can improve stool quality of animals, including pets/companion animals such as cats and dogs.

In certain aspects of the present disclosure, keratin-containing materials suitable for the methods herein include, but are not limited to, animal byproducts such as, e.g., feathers, hair, wool, hide, bristles, horns, beaks, hooves, claws, nails, scales, and mixtures thereof. The keratin-containing materials can be unprocessed or raw, meaning that the materials are obtained from a natural source, e.g., living animals that have shed the material(s) or as byproducts removed before and/or during meat processing.

Optionally, the raw/unprocessed keratin-containing material can undergo one or more pretreatment steps to remove extraneous components, such as blood, offal, residual tissue, and/or foreign bodies (e.g., wood, plastics, metals, stones, etc.). The pretreatment step(s) can include cleaning the raw/unprocessed keratin-containing material, such as by washing with ambient or hot water. Optionally, a suitable surfactant can be used with ambient or hot water during washing.

Processing of the keratin-containing materials herein can include thermal hydrolysis at acidic pH, e.g., for protein hydrolysis. In certain embodiments, thermal hydrolysis can employ steam under gentle processing conditions. In certain embodiments, the keratin-containing material can be subjected to steam hydrolysis at atmospheric pressure (0 psig=101325 Pa) or under pressure, e.g., a pressure greater than 0 psig to about 100 psig (790801 Pa), e.g., from about 10 psig to about 50 psig, or about 25 psig to about 75 psig. Steam hydrolysis can be performed for at least 1 minute, e.g., about 1 minute up to 60 minutes or more, or a time period of from about 1 minute to about 60 minutes, from about 15 minutes to about 60 minutes, from about 1 minute to about 10 minutes, or from about 3 minutes to about 15 minutes. In some aspects of the present disclosure, a keratinous protein-containing material can be subjected to steam hydrolysis at a pressure from about 0 psig to about 100 psig for about 1 minute, about 5 minutes, about 10 minutes, about 15 minutes, about 20 minutes, about 25 minutes, about 30 minutes, or about 35 minutes. Various forms of agitation (e.g., shaking or stirring) optionally can be applied during steam hydrolysis, e.g., to promote even application of heat throughout the material.

Before and/or during steam hydrolysis, the pH of the keratin-containing material can be maintained at an acidic pH. In certain embodiments, an acid or acidic solution can be added to the material and/or combined with the steam to provide a pH of 5 or less. In certain embodiments, the pH of the keratin-containing material can range from about 2 to about 5, alternatively from about 3 to about 5, about 4 to about 5, about 2.5 to about 4.5, or about 2 to about 3.5. In certain embodiments, examples of acids that can be used to lower pH to the desired range include, but are not limited to, hydrochloric acid (e.g., hydrochloric acid solution), phosphoric acid (e.g., phosphoric acid solution), sulfuric acid (e.g., sulfuric acid solution), and organic acids such as citric acid, acetic acid, malic acid, lactic acid, propionic acid, and tartaric acid, among other suitable acids.

In certain embodiments, an acid can be mixed with water and heated with steam, to achieve a pH of about 2 to about 5, and the keratinous material subsequently added to undergo steam hydrolysis. Additionally, or alternatively, steam can be continuously introduced into an acidic solution and applied to the keratinous material to provide a pH of about 5 or less. The pH can be adjusted as necessary (e.g., addition of acid, or addition of base if the pH is too low) to maintain the desired pH for the duration hydrolysis.

The methods disclosed herein can include one or more size reduction steps to provide particulate keratin-containing material with a desired particle size distribution. In certain embodiments, size reduction techniques include, but are not limited to, grinding (e.g., using a grinder for coarse and/or fine grinding) and milling (e.g., using a ball mill). The one or more size reduction steps can be performed before, during, or after any other step of the methods herein. In certain embodiments, size reduction can occur before and/or after steam hydrolysis, and/or can occur before and/or after lowering the pH of the keratin-containing material. In certain embodiments, a raw/unprocessed keratin-containing material (e.g., feather material) can be subjected to coarse grinding, followed by hydrolysis. Further, In certain embodiments, a raw/unprocessed keratin-containing material (e.g., feather material) can undergo hydrolysis, and the resulting hydrolyzed keratin-containing material can be subjected to fine grinding. In another embodiment, a raw/unprocessed keratin-containing material (e.g., feather material) can be subjected to coarse grinding followed by hydrolysis, and subsequently, the hydrolyzed keratin-containing material can be subjected to fine grinding. Without being bound by theory, it is believed that reducing the particle size of the keratin-containing material, in combination with steam hydrolysis at acidic pH can promote cleavage of cysteine disulfide bonds to increase digestibility while minimizing lanthionine formation.

Size reduction can be completed in a single step or multiple steps, e.g., two, three, four, or more size reduction steps to achieve a desired particle size. Each size reduction step can be performed before, during, or after another processing step (e.g., pretreatment, steam hydrolysis, and/or lowering pH), or two or more size reduction steps can be performed in sequence before, after, or during another processing step. The one or more size reduction steps can provide a particle size distribution wherein at least about 90% by weight of the keratin-containing material has an average particle size less than about 160 μm. The average particle size (d₅₀) refers to the value at which 50% by weight of the particles have a diameter less than that d₅₀ value (50% by weight of the particles are retained on sieves with openings of the given size and larger sizes). Similarly, the d₉₀ particle size refers to the value at which 90% by weight of the particles have a diameter less than that d₉₀ value (10% by weight of the particles are retained on sieves with openings of the given size and larger sizes), and the d₁₀ particle size refers to the value at which 10% by weight of the particles have a diameter less than that d₁₀ value (90% by weight of the particles are retained on sieves with openings of the given size and larger sizes). Particle size can be measured by laser diffraction analysis or optical image particle size analysis.

In certain nonlimiting embodiments, the keratin-containing material has a particle size distribution wherein the d₁₀ particle size ranges from about 1 μm to about 30 μm, the d₅₀ particle size ranges from about 30 μm to about 70 μm, and/or the d₉₀ particle size ranges from about 80 μm to about 250 μm. In certain embodiments, the keratin-containing material has a particle size distribution wherein the d₁₀ particle size ranges from about 10 μm to about 25 μm, the d₅₀ particle size ranges from about 45 μm to about 60 μm, and/or the d₉₀ particle size ranges from about 95 μm to about 160 μm. Further, in certain embodiments, the keratin-containing material has a particle size distribution wherein the d₁₀ particle size ranges from about 15 μm to about 25 μm, the d₅₀ particle size ranges from about 45 μm to about 55 μm, and/or the d₉₀ particle size ranges from about 90 μm to about 110 μm.

After the hydrolysis process, the hydrolyzed keratin-containing material can be subjected to one or more steps of drying, concentrating, refrigerating, and/or freezing. In certain embodiments, the hydrolyzed keratin-containing material can be dried by a suitable drying method to provide ambient shelf stability. Suitable drying methods include, but are not limited to, drum drying, spraying drying, fluidized bed drying, ring drying, and freeze drying. In certain embodiments, the one or more size reduction steps and drying can be performed simultaneously.

The dried, processed or hydrolyzed keratin-containing material prepared according to the methods herein can have a lanthionine content of about 1.0 wt % or less, about 0.7 wt % or less, or about 0.5 wt % or less. In certain embodiments, the dried, processed or hydrolyzed keratin-containing material can have an undetectable lanthionine content (i.e., lanthionine cannot be detected within measurement uncertainty) or a lanthionine content ranging from about 0.01 wt % to about 1.0 wt %, from about 0.01 wt % to about 0.5 wt %, from about 0.05 wt % to about 0.45 wt %, from about 0.15 wt % to about 0.4 wt %, from about 0.1 wt % to about 0.3 wt %, from about 0.2 wt % to about 0.5 wt %, from about 0.25 wt % to about 0.45 wt %, from about 0.3 wt % to about 0.45 wt %, or from about 0.35 wt % to about 0.5 wt %. In certain embodiments, the dried, processed or hydrolyzed keratin-containing material can have a lanthionine content less than about 0.4 wt %, less than about 0.35 wt %, or less than about 0.2 wt %, e.g., ranging from greater than zero to less than about 0.04 wt %, less than about 0.03 wt %, less than about 0.02 wt %, or less than about 0.01 wt %.

According to an a nonlimiting embodiment of the present disclosure, a raw/unprocessed keratin-containing material (e.g., feather material) can optionally undergo a pretreatment step to remove blood and/or other extraneous non-protein and/or foreign body material. After pretreatment, the keratin-containing material can undergo a size reduction step, e.g., coarse grinding, to reduce particle size. The keratin-containing material then can be combined with an acidic solution to provide for an acidic pH, e.g., a pH ranging from about 3.5 to about 5. Next, the acidic keratin-containing material can undergo at least one additional size reduction step, e.g., by ball milling, to achieve a d₅₀ particle size ranging from about 30 μm to about 70 μm, in certain embodiments ranging from about 40 μm to about 60 μm, or from about 45 μm to about 55 μm. Additionally or alternatively, the d₉₀ particle size of the acidic keratin-containing material can range from about 80 μm to about 160 μm, in certain embodiments ranging from about 95 μm to about 110 μm, or from about 90 μm to about 105 μm. Next, steam hydrolysis can be performed while maintaining a pH of about 5 or less. After hydrolysis, the hydrolyzed keratin-containing material can be dried using a suitable drying method as discussed above. The resulting dried, hydrolyzed keratin-containing material can have a lanthionine content less than about 1.0 wt % or less than about 0.5 wt %. In certain embodiments, the lanthionine content ranges from about 0.01 wt % to about 0.5 wt %, or from about 0.01 wt % to about 1.0 wt %. Alternatively, the lanthionine content ranges from about 0.5 wt % to about 1.0 wt %,

According to another embodiment of the present disclosure, a raw/unprocessed keratin-containing material (e.g., feather material) can optionally undergo a pretreatment step to remove blood and/or other extraneous non-protein and/or foreign body material. The keratin-containing material then can undergo one or more size reduction steps, e.g., coarse cutting or coarse grinding followed by fine grinding, to achieve a d₅₀ particle size ranging from about 30 μm to about 70 μm, or ranging from about 40 μm to about 60 μm, or from about 45 μm to about 55 μm. Additionally or alternatively, the d₉₀ particle size of the acidic keratin-containing material can range from about 80 μm to about 160 μm, or ranging from about 95 μm to about 110 μm, or from about 90 μm to about 105 μm. Next, the keratin-containing particles can be combined with an acidic solution to provide for an acidic pH, e.g., a pH ranging from about 3.5 to about 5. Next, the acidic keratin-containing particles can undergo steam hydrolysis while maintaining a pH of about 5 or less. After hydrolysis, the hydrolyzed keratin-containing particles can be dried using a suitable drying method as discussed above. The resulting dried, hydrolyzed keratin-containing particles can have a lanthionine content less than about 1.0 wt %, or less than about 0.5 wt %. In certain embodiments, the lanthionine content ranges from about 0.01 wt % to about 0.5 wt %, or from about 0.01 wt % to about 1.0 wt %. Alternatively, the lanthionine content ranges from about 0.01 wt % to about 1.0 wt %.

According to another embodiment of the present disclosure, a raw/unprocessed keratin-containing material (e.g., feather material) can optionally undergo a pretreatment step to remove blood and/or other extraneous non-protein and/or foreign body material. Optionally after pretreatment, the keratin-containing material can undergo one or more size reduction steps, e.g., coarse cutting or coarse grinding to reduce particle size. The keratin-containing material then can be combined with an acidic solution to provide for an acidic pH, e.g., a pH ranging from about 3.5 to about 5. Next, the acidic keratin-containing material can undergo steam hydrolysis while maintaining a pH of about 5 or less. Next, the hydrolyzed keratin-containing material can undergo one or more size reduction steps, e.g., by ball milling or other suitable method, to achieve a d₅₀ particle size ranging from about 30 μm to about 70 μm, or ranging from about 40 μm to about 60 μm, or from about 45 μm to about 55 μm. Additionally or alternatively, the d₉₀ particle size of the hydrolyzed keratin-containing material can range from about 80 μm to about 160 μm, or ranging from about 95 μm to about 110 μm, or from about 90 μm to about 105 μm. After hydrolysis, the hydrolyzed keratin-containing particles can be dried using a suitable drying method as discussed above. The resulting dried, hydrolyzed keratin-containing material can have a lanthionine content less than 1.0 wt %, or less than 0.5 wt %. In certain embodiments, the lanthionine content ranges from about 0.01 wt % to about 0.5 wt %, or from about 0.01 wt % to about 1.0 wt %. Alternatively, the lanthionine content ranges from about 0.01 wt % to about 1.0 wt %.

The hydrolyzed keratin-containing material (e.g., dried hydrolyzed keratin-containing material) prepared according to the present disclosure can be useful in food compositions, including pet food products. The relatively low lanthionine content can avoid adverse results associated with foods that contain high amounts of lanthionine. In certain embodiments, high lanthionine content in pet food compositions are often associated with poor and unacceptable stool quality in pets, e.g., softer feces, loose stool, diarrhea, etc.

The relatively low lanthionine content achieved by the methods herein allows for comparatively greater amounts of keratin-containing material in pet food compositions without relatively high amounts of lanthionine. The lanthionine content in commercially available feather meals is typically over about 1 wt %, e.g., a range of from about 1 wt % to about 3 wt % or more, with an average value of about 2 wt %.

Table 1 provides guidance for feather meal (FM) provided as a weight percentage of dry pet food for dogs and cats, based on the expected lanthionine content in the feather meal and its expected effect on the quality of the pet's stool or feces. The evaluation of pet stool (determination of unacceptable or acceptable) is based on the following rating/scoring system: 1=hard, dry pellets: small, hard mass; 2=hard, formed dry stool: remains firm and soft; 3=soft, formed, moist: softer stool that retains its shape; 4=soft, unformed: stool assumes shape of container, pudding-like; 5=watery: liquid that can be poured. For certain embodiments of the present disclosure, a stool quality value less than about 2 and/or greater than about 4 is considered unacceptable.

A lanthionine content less than or equal to about 0.2 wt %, such as less than or equal to about 0.15 wt %, less than or equal to about 0.1 wt % or less than or equal to about 0.05 wt % in a pet food composition is expected to produce or contribute to acceptable feces/stool quality. A lanthionine content above about 0.2 wt % in a pet food composition is expected to produce or contribute to softer feces which falls outside of the acceptable standard for feces/stool quality.

Table 1 provides guidelines for incorporating feather meal into a pet food composition. A lanthionine (LAN) content of about 2 wt % in feather meal (FM) is assumed for comparison purposes and does not account for other contributors to the lanthionine level, such as, e.g., poultry meal, chicken meal, and chicken byproduct meal. Table 1 demonstrates that using more than about 5 wt % of feather meal that has about 2% lanthionine is likely to result in unacceptable stool quality, restricting the amount of keratinaceous protein that can be used. As the present disclosure allows for lower lanthionine content, higher amounts of keratinaceous protein can be used in addition to, and/or in replacement or partial replacement of, animal protein.

TABLE 1

| Target FM inclusion | | Expected LAN |
|---|---|---|
| (wt % of food) assuming | | level in pet food |
| 2 wt % LAN in FM | Stool Quality | (wt % of food) |
| Up to 2.5 wt % | Likely Acceptable | ≤0.05 wt % |
| 2.5-5 wt % | Potentially acceptable | 0.05 wt %-0.10 wt % |
| Over 5 wt % | Likely Unacceptable | ≥0.10 wt % |

As mentioned above, the present disclosure includes compositions comprising the hydrolyzed keratin-containing material. In certain embodiments of the present disclosure, the pet food composition can comprise up to about 0.2% by weight of lanthionine. In certain embodiments, the pet food composition can comprise about 0.1% or less by weight of lanthionine, such as from about 0.01% to about 0.1% by weight of lanthionine.

The hydrolyzed keratin-containing materials herein be used in pet food compositions to partially replace other protein sources such as, e.g., poultry meal, chicken meal, chicken byproduct meal, turkey, beef, pork, lamb, venison, duck, salmon, other dried animal protein materials, and/or plant protein materials (e.g., corn gluten meal, wheat gluten, etc.). In certain embodiments, the composition comprises up to about 20% by weight of the hydrolyzed keratin-containing material, relative to the total weight of the composition. In certain embodiments, the composition can comprise greater than zero to about 20% or less by weight, about 1% to about 18% by weight, about 5% to about 15% by weight, about 10% to about 15% by weight, about 16% to about 20% by weight, about 8% to about 12% by weight, about 3% to about 7% by weight, about 1% to about 6% by weight, or about 12% to about 16% by weight, relative to the total weight of the composition (e.g., pet food composition). Additional components of the composition can include a combination of carbohydrates, fats, vitamins, fiber (e.g., crude fiber), and/or minerals. In certain embodiments, carbohydrates include, but are not limited to, corn, rice, wheat, sorghum, and barley. In certain embodiments, fats include, but are not limited to, poultry fat, beef tallow, and vegetal oil. In certain embodiments, the composition according to the present disclosure comprises from about 1% to about 20% by weight of dried hydrolyzed keratin-containing material, from about 5% to about 35% by weight of another protein source (e.g., about 10% to about 25% by weight, or about 15% to about 30% by weight), from about 30% to about 60% by weight of carbohydrates (e.g., from about 40% to about 50% or from about 45% to about 55% by weight), and/or from about 2% to about 10% by weight of fats (e.g., from about 4% to about 8% or from about 5% to about 7% by weight). In certain embodiments, a composition can comprise from about 1% to about 10% by weight of dried hydrolyzed keratin-containing material, from about 5% to about 35% by weight of another protein source, from about 45% to about 50% carbohydrates, and from about 5% to about 7% by weight of fats. In such embodiments, the other protein source can be animal-based or plant-based.

Improved digestibility of keratin-containing materials by the methods of the present disclosure can be quantified using Boisen digestibility (also known as ileal digestibility), a parameter discussed in Boisen and Fernandez (Animal Feed Science and Technology, 68:277-286, 1997). Boisen digestibility of hydrolyzed keratin containing material of the present disclosure can be inversely proportional to size reduction. In certain embodiments, as the size of the particles is reduced, the Boisen digestibility of the keratin containing materials can increase. Boisen digestibility is determined by an in vitro analysis method, which uses enzymatic reactions to simulate stomach and subsequent small intestine digestive conditions. Boisen digestibility can be measured by simulating stomach digestion (pepsin) followed by small intestine digestion (pancreatin) to determine the amount of undigested protein remaining.

The procedure is as follows:
Prepare sample solution by combining 1 g dry sample (dry hydrolyzed keratin-containing material) with 0.1 M phosphate buffer (pH 6) and 0.2 N hydrochloric acid (HCl), then adjusting pH to 2±0.02 using 1 N HCl and/or 1 N NaOH.
Add 1 mL of aqueous pepsin solution (10 mg/mL) and incubate for 6 hours at 39° C. under constant agitation.
Adjust the pH to 6.8±0.2 using 1 N HCl solution and/or 1 N NaOH.
Add 1 mL of aqueous pancreatin solution (50 mg/mL) and incubate for 18 hours at 39° C. under constant agitation.
Add 5 mL of 20% sulfosalicylic acid solution, let sit for 1 hour at room temperature (25° C.), and then filter to collect the precipitate (undigested protein); rinse with water as necessary to collect all precipitate.
Dry the precipitate overnight at approximately 100° C., then weigh.
   Boisen digestibility is calculated as follows:

$$Boisen Digestibility = ( ( A - B ) / A ) * 100 \%$$

where A=protein in original sample (g) and B=protein in precipitate (g)/100.

Boisen digestibility of the hydrolyzed keratin-containing materials prepared according to the methods herein can be greater than about 70%, such as ranging from about 70% to about 90%, e.g., a Boisen digestibility ranging from about 75% to about 85%.

While principles of the disclosure are described herein with reference to exemplary compositions and methods, it should be understood that the disclosure is not limited thereto. Those having ordinary skill in the art and access to the teachings provided herein will recognize additional modifications, applications, aspects, and substitution of equivalents all fall within the scope of the aspects described herein. Accordingly, the disclosure is not to be considered as limited by the foregoing description.

Other exemplary embodiments of this disclosure will be apparent to those skilled in the art from consideration of the specification and practice of the exemplary embodiments disclosed herein. It is intended that the specification and examples be considered as exemplary only, and departures in form and detail can be made without departing from the scope and spirit of this disclosure as defined by the following claims.

1. A method for preparing a hydrolyzed keratin-containing material, the method comprising:
combining a keratin-containing material with an acid;
processing the keratin-containing material by steam hydrolysis; and
reducing a particle size of the keratin-containing material to a d₅₀ particle size of 100 μm or less.

2. The method of claim 1, wherein the keratin-containing material is combined with the acid to achieve a pH ranging from about 2 to about 5 before and/or during processing by steam hydrolysis.

3. The method of claim 1, wherein reducing the particle size occurs before combining with the acid, before the processing by steam hydrolysis, and/or after the processing by steam hydrolysis.

4. The method of claim 1, wherein the processing by steam hydrolysis is performed at a pressure of from about 0 to about 100 psig.

5. The method of claim 1, wherein the keratin-containing material comprises feathers, hair, wool, beaks, hide, bristles, horns, hooves, claws, nails, scales, or a mixture thereof.

6. The method of claim 1, wherein the hydrolyzed keratin-containing material comprises 1.0% by weight or less of lanthionine, relative to the total weight of the hydrolyzed keratin-containing material, optionally 0.5% by weight or less of lanthionine.

7. A hydrolyzed keratin-containing material prepared according to the method of claim 1.

8. The hydrolyzed keratin-containing material of claim 7, wherein the hydrolyzed keratin-containing material has a lanthionine content of 0.25% by weight or less relative to the total weight of the hydrolyzed keratin-containing material.

9. The hydrolyzed keratin-containing material of claim 7, wherein the hydrolyzed keratin-containing material has a d₁₀ particle size ranging from about 1 μm to about 30 μm and/or a d₉₀ particle size ranging from about 80 μm to about 160 μm, and/or wherein the d₅₀ particle size ranges from about 30 μm to about 70 μm.

10. The hydrolyzed keratin-containing material of claim 7, wherein the hydrolyzed keratin-containing material has a Boisen digestibility of about 70% to about 90%.

11. A composition comprising the hydrolyzed keratin-containing material of claim 7, wherein the composition is a pet food composition.

12. The composition of claim 11, wherein the composition comprises about 1% by weight to about 20% by weight of the hydrolyzed keratin-containing material.

13. The composition of claim 11, wherein the composition comprises 0.2% by weight or less of lanthionine, relative to the total weight of the composition, such as about 0.01% to 0.2% by weight of lanthionine.

14. The composition of claim 11, wherein the hydrolyzed keratin-containing material is hydrolyzed feather meal.

15. The composition of claim 11, wherein the composition further comprises at least one protein source other than the hydrolyzed keratin-containing material.

16. The composition of claim 15, wherein the at least one protein source other than the hydrolyzed keratin-containing material comprises an animal-based protein such as chicken, turkey, beef, pork, lamb, venison, duck, or salmon, and/or a plant-based protein such as corn gluten meal or wheat gluten.

17. The composition of claim 11, wherein the composition further comprises at least one carbohydrate such as corn, rice, wheat, sorghum, or barley; and/or at least one fat such as poultry fat, beef tallow, or vegetal oil.

18. A method for improving stool quality in an animal, the method comprising administering the composition of claim 11 to the animal.

19. The method of claim 18, wherein the composition is a dry pet food.

20. The method of claim 18, wherein the animal is a dog or a cat.

21. The method of claim 18, wherein the stool quality value of the animal is about 2 to about 4.

22. (canceled)

23. (canceled)

24. A hydrolyzed keratin-containing material comprising 1.0% by weight or less of lanthionine, optionally less than or equal to 0.5% by weight lanthionine, relative to the total weight of the hydrolyzed keratin-containing material; wherein the hydrolyzed keratin-containing material has a d₁₀ particle size ranging from about 1 μm to about 30 μm, a d₉₀ particle size ranging from about 80 μm to about 160 μm, and/or a d₅₀ particle size ranging from about 30 μm to about 70 μm.

25. The hydrolyzed keratin-containing material of claim 24 wherein the hydrolyzed keratin-containing material comprises hydrolyzed feather meal.

26. A composition comprising:
about 1% by weight to about 20% by weight of a hydrolyzed keratin-containing material; and
at least 5% by weight of a protein source other than the hydrolyzed keratin-containing material;
wherein the composition is a pet food composition; and
wherein the composition comprises 0.2% by weight or less of lanthionine, such as 0.1% by weight or less of lanthionine, relative to the total weight of the composition.

27. The composition of claim 26, wherein the protein source other than the hydrolyzed keratin-containing material comprises an animal-based protein such as chicken, turkey, beef, pork, lamb, venison, duck, or salmon, and/or a plant-based protein such as corn gluten meal or wheat gluten.

28. The composition of claim 26, wherein the composition further comprises at least one carbohydrate such as corn, rice, wheat, sorghum, or barley; and/or at least one fat such as poultry fat, beef tallow, or vegetal oil.
